(19) United States
(12) Patent Application Publication
(10) Pub. No.: US 2012/0275163 A1
(43) Pub. Date: Nov. 1, 2012

(54) LIGHTING DEVICE AND LIGHT SOURCE MODULE THEREOF

(75) Inventor: CHIN-HUEI CHEN, NEW TAIPEI CITY (TW)

(73) Assignee: ENERGYLED CORPORATION, NEW TAIPEI CITY (TW)

(21) Appl. No.: 13/244,520

(22) Filed: Sep. 25, 2011

(30) Foreign Application Priority Data
Apr. 29, 2011 (TW) 100207444

(51) Int. Cl. F21V 29/02; F21V 7/00

(52) U.S. Cl. 362/294; 362/382

(57) ABSTRACT

A lighting device includes a heat-removal apparatus, a light source module and a lampshade. The heat removal apparatus has a column member, a plurality of fins are extended outwardly therefrom, wherein a plurality of heat-dissipating passages are formed axially in the column member; the light source module is disposed on one end surface of the column member, and near the heat-dissipating passages; the lampshade can reflect light of the light source module. The air current would propagate upward through the light source module, the heat removal apparatus, and exit the lighting device outside, cold air is inhaled the bottom portion of the heat-dissipating passages, thereby promoting air current circulation.

### BACKGROUND OF THE INVENTION

1. Field of the Invention

The instant disclosure relates to a light device and light source module thereof; more particularly, to a high power lighting device having a heat sink and a light source module thereof for hanging in large indoor or outdoor environment to provide wide area lighting.

2. Description of Related Art

High power high bay lights are widely utilized to provide wide area lighting for both indoor and outdoor environments. For example, conventional high by lights that utilize mercury lamps as light source can be commonly seen suspended on the ceiling of large factories, supermarkets, or outdoor environment. Because of the advancement in high-power light emitting diodes (LEDs) technology, LED devices are now capable of being adapted as the light sources for the high bay lights. For current high-power LEDs, the input power is 20% converted into the light, and the remaining is transformed into the heat. When the heat does not disperse immediately, the LEDs may overheat, thus reducing the efficiency of LEDs and the life thereof.

Therefore, the development of the lighting device may be benefit to dissipate the heat immediately; more particularly, to the lighting device having high-wattage and the light source module thereof.

### SUMMARY OF THE INVENTION

The instant disclosure provides a lighting device having a heat removal apparatus that utilizes stack-effect to induce air circulation and enhance heat dissipating efficiency, thus ensuring the life of light source unit.

The instant disclosure also provides a light source module for coupling to the heat removal apparatus, so that air current can smoothly flow through the periphery of the light source module and through the heat removal apparatus.

According to the above-mentioned of the instant disclosure, the lighting device includes a heat removal apparatus and a light source module. The heat removal apparatus has a column member with first and second end surfaces, a plurality of fins which are extended outwardly a periphery of the column member. The column member has a plurality of heat-dissipating passages enabling air communication between the end surfaces. The light source module is disposed on the first end surface of the column member and near the heat-dissipating passages. The light source module includes a light source unit and a light seat member having a plurality of air vents arranged thereon. The light source unit is fixed to one end of the heat removal apparatus. The light seat member covers the light source unit. The air vents are aligned to the head-dissipating passages of the heat removal apparatus.

The heat-dissipating passages are configured to induce air current through stack-effect to dissipate the heat generated by the light source module. When the air current flows upward through the light source module and the heat removal apparatus, and then exits the lighting device. The extraction of warmer air from the top portion of the heat removal device through the heat dissipating passages then causes cold air to be drawn into the bottom portion of the heat-dissipating passages, thereby promoting air current circulation.

According to the above-mentioned other aspect of the instant disclosure, a light source module is provided and corresponds to a heat-removal apparatus having a plurality of heat-dissipating passages penetrating therethrough along a longitudinal direction thereof. The light source module includes a light source unit, a light seat member and an air vent. The light source unit is fixed to one end of the heat removal apparatus. The light seat member covers the light source unit. The air vents are formed in the light seat member and aligned to the heat removal apparatus. Thus, air current can flow through the periphery of light seat member, the air vents, and through to the heat-dissipating passages.

The instant disclosure has the following advantages. Namely, the heat-dissipating passages are available to guide air current through stack-effect in the heat-dissipating passages to dissipate the heat being generated by the light source module. The air current would flow upward through the light source module, the heat removal apparatus, and exit the lighting device outside. Thus, cold air can be drawn into the bottom portion of the heat-dissipating passages, thereby promoting air current circulation. Hot air is denser and lighter than cold air. Therefore, hot air would flow upward through the heat-dissipating passages and exit from the top portion of the column member. After the dissipation of hot air, cold air from outside can be drawn into the bottom portion of the heat-dissipating passages, thereby promoting air current circulation.

In order to further appreciate the characteristics and technical contents of the instant disclosure, references are hereunder made to the detailed descriptions and appended drawings in connection with the instant disclosure. However, the appended drawings are merely shown for exemplary purposes, rather than being used to restrict the scope of the instant disclosure.

### BRIEF DESCRIPTION OF THE DRAWINGS

FIG. 1 shows a perspective view of a lighting device of the instant disclosure;

FIG. 2 shows an exploded view of a light seat member and a light-focus module of the instant disclosure;

FIG. 3 shows another exploded view of the light seat member and the light-focus module of the instant disclosure;

FIG. 4 shows a perspective view of the lighting device of the instant disclosure; and

FIG. 5 shows an isometric sectional view of the lighting device of the instant disclosure.

### DETAILED DESCRIPTION OF THE PREFERRED EMBODIMENTS

The aforementioned illustrations and following detailed descriptions are exemplary for the purpose of further explaining the scope of the present invention. Other objectives and advantages related to the present invention will be illustrated in the subsequent descriptions and appended drawings.

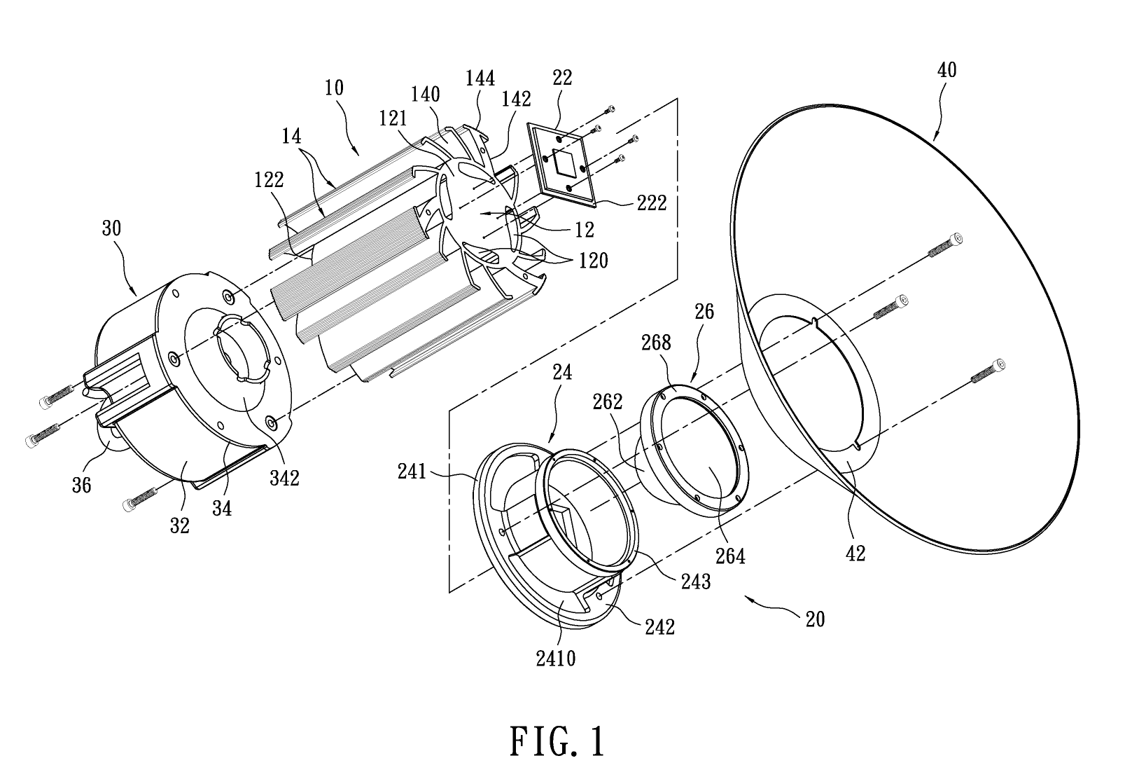

Please refer to FIG. 1, which shows a perspective view of a lighting device of the instant disclosure. The lighting device is available to factories, spacious indoor or outdoor environment, etc. For example, a high bay light can be suspended in the ceiling. The disclosed lighting device includes a heat removal apparatus 10, a light source module 20, a power converter 30 and a lampshade 40.

The heat removal apparatus 10 has the same cross section. In a preferred embodiment, the manufacture method can use extrusion method, for example aluminum extrusion or copper extrusion. The heat removal apparatus 10 has a column member 12 and a plurality of fins 14 which are outwardly projecting from a periphery of the column member 12. The column member 12 has first and second end surfaces (121, 122), and a plurality of heat-dissipating passages 120 which are formed axially in the column member 12 and adjacent to the column member 12. Each of fins 14 has extending walls 142 and heat-dissipating walls 144. The extending walls 142 are extended outwardly from the column member 12; the heat-dissipating walls 144 are connected to the extending wall 142. The exterior surface of the heat-dissipating walls 144 forms wavy structure to increases the area of heat dissipation. The column member 12 of instant disclosure resemble cylinder-shaped. The heat-dissipating walls 144 are parallel in the circumference direction of the column member 12, and are located in the identical circumference. The column member 12 is separated from each other by an outer passages 140 formed in-between.

The column member 12 has two opposite end surfaces, namely, top and bottom end surfaces 121 and 122. According to the suspension condition of lamp, the bottom end surface is defined as first end surface 121; the other end (being the top end) of the column member 12 is defined as second end surface 122. The light source module 20 is disposed on first end surface 121 of the column member 12 and near the heat-dissipating passages 120. In this embodiment, the light source module 20 can be high-wattage (50 W to 100 W) LED. The light source module 20 includes a light source unit 22, a light seat member 24 and a light-focus module 26. The light source unit 22 is fixed to one end of the heat removal apparatus 10. The light seat member 24 covers the light source unit 22. The light-focus module 26 is accommodated in the light seat member 24 to focus the light rays from the light source unit 22. The source unit 22 is fixed on the first end surface 121 of the column member 12 via screws, and has a bottom surface adhered to the column member 12, and preferably use thermal paste to increase the heat conduction performance. The source unit 22 can further includes a waterproof silicone O-ring 222 to prevent the ingress of moisture.

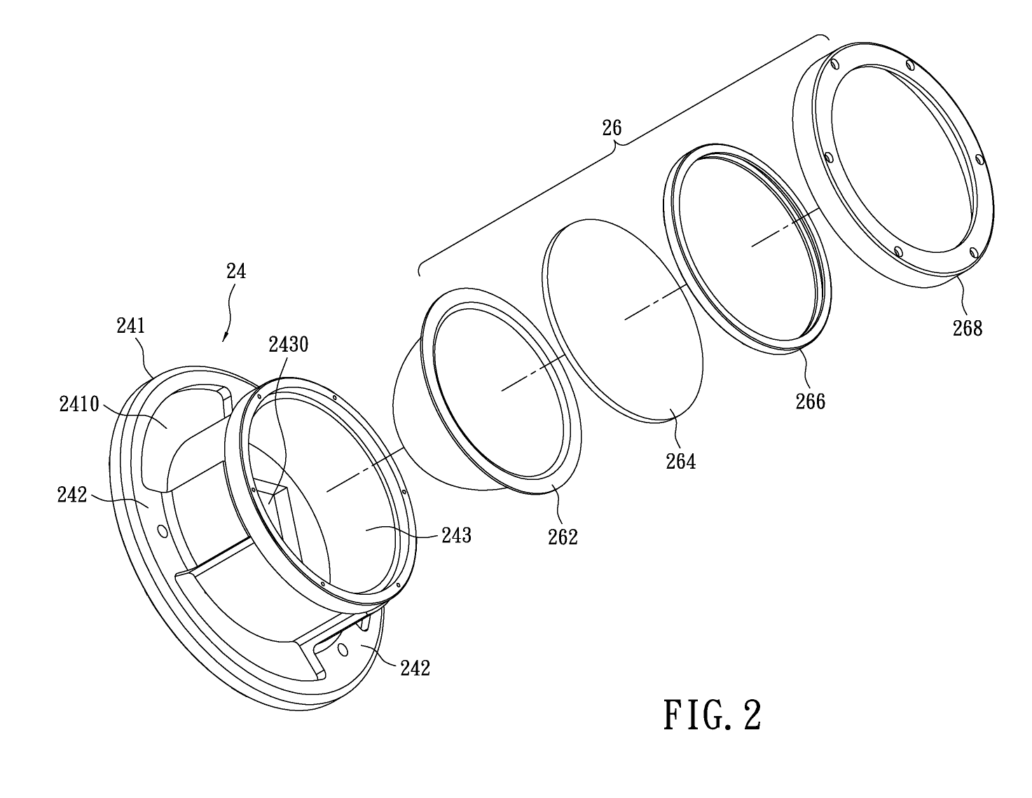

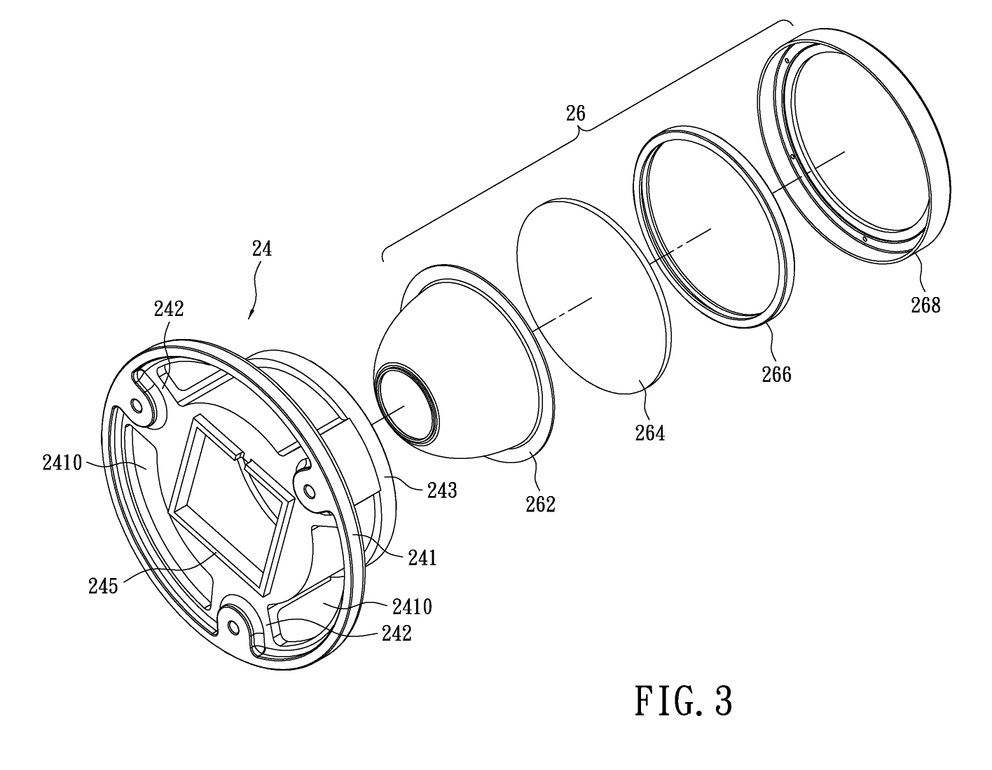

Please refer to FIGS. 2 and 3, which shows an exploded view of the light seat member 24 and the light-focus module 26 of the instant disclosure. The light seat member 24 has a disk-shaped bottom frame 241, a plurality of connection portions 242 which are extended inwardly from the disk-shaped bottom frame 241, and a barrel-shaped portion 243 which is connected to the connection portions 242. A plurality of air vents 2410 is formed between the disk-shaped bottom frame 241 and the barrel-shaped portion 243. In this embodiment, each two neighboring connection portions 242 are separated from one of the air vents 2410. The disk-shaped bottom frame 241 is contacted with the first end surface 121 of the heat removal apparatus 10. The light seat member 24 can be formed integrally, or fixed on the connection portions 242 by screws via barrel-shaped portion243.

A light-source opening 2430 is formed in the middle-bottom of the barrel-shaped portion 243, and the light source unit 22 is disposed in the light-source opening 2430. The area of the bottom surface of the barrel portion 243 is substantially equal to that of the column member 12. A frame portion 245 is disposed the bottom surface of the barrel-shaped portion 243 and located in the periphery of the light-source opening 2430. The frame portion 245 abuts against the first end surface 121 of the column member 12, and the bottom of the light seat member 24 is partially contacted with the column member 12. In this embodiment, the frame portion 245 is square-shaped, and its size is greater than that of the light source unit 22. The frame portion 245 covers the periphery of the light source unit 22, and is disposed between the heat-dissipating passages 120. A small gap is formed between the barrel-shaped portion 243 outside of the frame portion 245 and the first end surface 121 of the column member 12. The gap allows air current to flow through the air vent 2410 to the heat-dissipating passages 120.

The light-focus module 26 is accommodated in the barrel-shaped portion 243. The light-focus module 26 has a reflective lampshade 262, a transparent cover 264, a seal ring 266 and a ring-shaped cover 268. The reflective lampshade 262 is accommodated the barrel-shaped portion 243. The transparent cover 264 covers the reflective lampshade 262. The seal ring 266 is disposed on the periphery of the transparent cover 264. The seal ring 266 can be silicon O-ring to isolate moisture. The ring-shaped cover 268 can be made of metallic material, and covers on the seal ring 266, and is locked to the top end of the barrel-shaped portion 243.

Please refer to FIG. 1 again, a power converter 30 is disposed the second end surface 122 of the column member 12, which is used to transform power and supply the power to the light source module 20. The power converter 30 has a housing 32 and a guiding portion34 disposed the bottom of the housing 32. The power converter 30 is fixed to the heat removal apparatus 10, such as fixed by screws to the extending wall 142 of the fins 14. The guiding portion 34 of this embodiment has a guiding wall 342, which is cylinder-shaped with arc opening. The bottom portion of the guiding portion 34 abuts against the second end surface 122 of the column member 120. The guiding portion 34 is fixed on the bottom surface of the power converter 30 in screw way. A ring 36 can be fixed to the top surface of the power converter 30 for suspension. However, the power converter 30 can also be separated with the heat removal apparatus 10, and is connected by cord to the light source module 20. For example, the power converter 30 can be fixed on the ceiling of the steel frame (not shown).

In the preferred embodiment example, the fins 14 of the heat removal apparatus 10 extend beyond one end of the column member 12, which is the second end surface 122. In other words, the fins 14 can be formed a hollow space therebetween, wherein the fins 14 are slightly longer then the column member 12. The fins 14 abut against the outer surface of the guiding portion 34. The guiding portion 34 is located between the fins 14, in other words, it is located in the hollow space.

The preferred embodiment example also has a lampshade 40, which is disposed in the periphery of the light seat member 24. The lampshade 40 has a bottom portion 42. Screws pass through the bottom portion 42 of the lampshade 40 and the connection portion 242 of the light seat member 24, so that the lampshade 40 is fixed on the fins 14 of the heat removal apparatus 10. In this embodiment, the bottom portion 42 of the lampshade 40 is ring-shaded, and has an inner edge with an opening is bigger than the barrel-shaped portion 243. In other words, a distance is kept between the inner edge of the bottom portion 42 and the barrel-shaped portion 243, air current can make to propagate through the air vent 2410 to the heat-dissipating passages 120. However the bottom portion 42 of the lampshade 40 is not limited to the above shape, only need be able to coordinate the screw to fix it.

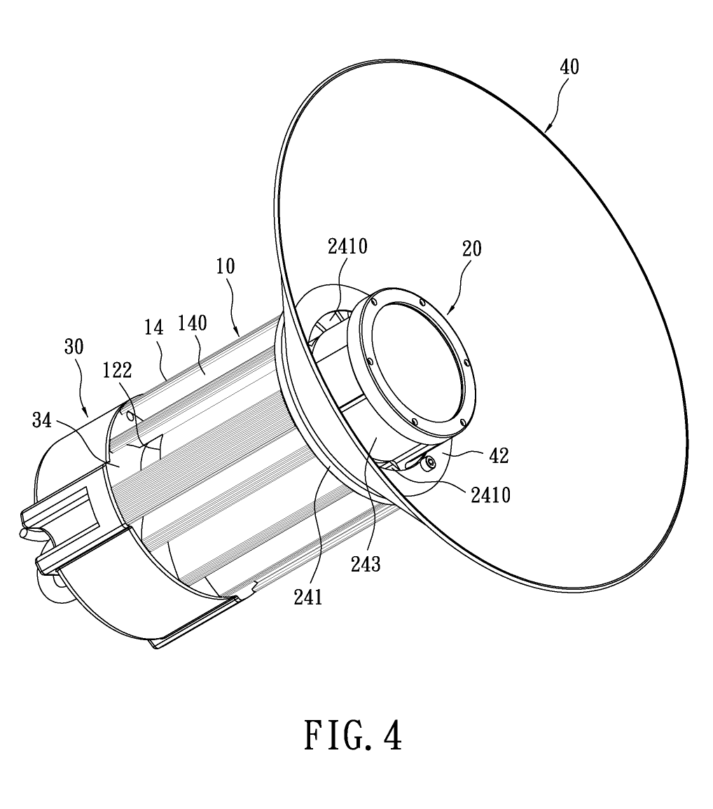

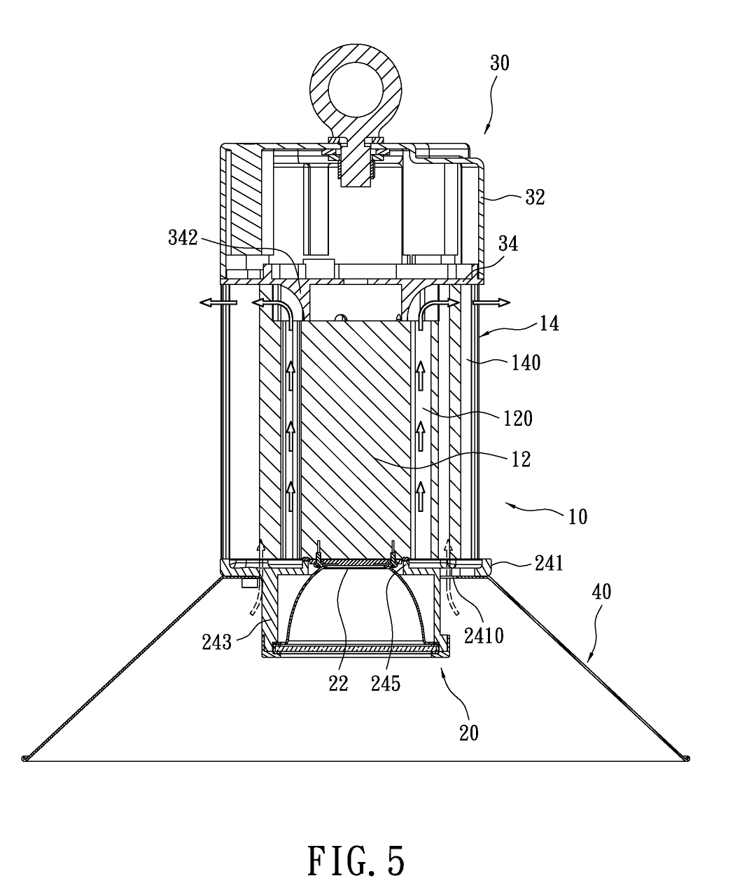

Please refer to FIGS. 4 and 5, which shows a perspective view and an isometric sectional of a lighting device of the instant disclosure. The heat from the light source unit 22 of the light source module 20 mainly is conducted to the heat removal apparatus 10, which can induce the air current to flow upward through the heat removal apparatus 10, and exit the guiding portion 34. Then, the cold air can be drawn into the bottom of the heat-dissipating passages 120 to enhance the air circulation to improve the heat-dissipating effect.

The air vent 2410, formed on the disk-shaped bottom frame 241 of the light seat member 24, is communicated with the inner space of the lampshade 40 and the outer passages 140 of the heat-dissipating walls 144. In addition, the air vent 2410 is also communicated with the heat-dissipating passages 120 by the gap, which is formed between the barrel-shaped portion 243 and the first end surface 121 of the column member 12. Therefore, the air current would flow through the outer of the light seat member 24 to the air vent 2410, and exit the outer passages 140 or the heat-dissipating passages 120 to improve the heat-dissipating effect. The heat of the light source unit 22 not only would flow through the heat removal apparatus 10 by heat conduction, but also flow through the outer of the barrel-shaped portion 243 to take off heat.

The instant disclosure has the following advantages. The heat-dissipating passage 120 is functioned and produces a stack-effect condition to accelerate air current circulation. The stack-effect refers to the thermo-compression to make to improve air current circulation flowing up along a channel/passage, which is formed by temperature difference between the indoor and outdoor. The hot air of the light source module 20 would flow upwardly the heat-dissipating passages 120, and exit the top of the column member 12. After the dissipation of hot air, cold air from outside can be drawn into the bottom portion of the heat-dissipating passages 120, thereby promoting air current circulation.

Each heat-dissipating passage 120 is available to guide one air current, wherein the air current is formed by stack-effect in the heat-dissipating passages to dissipate the heat being generated by the light source module 20. The air current would flow upward through the lampshade 40, the light source module 20, the heat removal apparatus 10 and the power converter 30, and exit the lighting device outside. Then, cold air is drawn or inhaled into the bottom portion of the heat-dissipating passages 120, thereby promoting air current circulation.

Additional remarks, thermo-compression is related to height of the column member 12, i.e. with the height difference between the entrance and export. Thermo-compression is also related to the temperature difference with the heat removal apparatus 10. The temperature and the height difference are bigger, and then the thermo-compression is obvious. Thus, the column member 12 needs to have certain altitude. Furthermore, one end surface of the heat-dissipating passages 120 to be good is vertical cavity; the other end surface is not too small to permit the air smoothly along the vertical direction circulation.

The instant disclosure only showed by above the preferred embodiment example, but does not limit to this. For example, the column member 12 may be formed middle channel; the light source module 20 may be the mercury lamp or the high-pressure sodium lamp; the light seat member 24 may be located in the middle channel to improve heat-dissipating effect.

The instant disclosure also has other advantages. For example high bay light is hanged at the high position; the maintenance and the replacement are not easy. Thus, it uses the LED with the long life to reduce the cost for the replacement of the light source. In addition, the consideration installs in the outdoors possibility to apply in the outdoor lighting.

The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

What is claimed is:

1. A lighting device, comprising:
a heat removal apparatus having a column member with first and second end surfaces, and a plurality of fins outwardly projecting from a periphery of the column member, the column member having a plurality of heat-dissipating passages enabling air communication between the end surfaces; and
a light source module disposed on the first end surface near the heat-dissipating passages, the light source module including a light source unit and a light seat member having a plurality of air vents arranged thereon, the light source unit being fixed to one end of the heat removal apparatus, the light seat member covering the light source unit, and the air vents being aligned to the heat-dissipating passages;
wherein each of the heat-dissipating passages is configured to induce air current through stack-effect to dissipate heat generated by the light source module, wherein when the air current flows upwardly by the light source module and the heat removal apparatus and exits the lighting device, cold air is drawn into a bottom end of the heat-dissipating passages, thereby promoting air current circulation.

2. The lighting device of claim 1, wherein the heat-dissipating passages are adjacent to the periphery of the column member.

3. The lighting device of claim 1, wherein each of the fins has a extending wall and a heat-dissipating wall, wherein the extending wall is extended outwardly from the periphery of the column member; the heat-dissipating wall is extended outwardly from the extending wall; the heat-dissipating wall forms a wavy structure on an exterior surface thereof.

4. The lighting device of claim 3, wherein the column member is cylinder-shaped, wherein the heat-dissipating walls are parallel in a circumference direction thereof, and are located in one identical circumference; wherein the heat-dissipating walls are separated from each other by an outer passages formed therebetween.

5. The lighting device of claim 3, further comprising a power converter disposed on the second end surface of the column member opposite to the light source module, wherein the power converter is fixed to the heat removal apparatus and has a guiding portion abutted against the second end surface of the column member.

6. The lighting device of claim 5, wherein the fins extend beyond the second end surface of the column member and defines a hollow space therebetween, the guiding portion is located in the hollow space, and the fins contact with an outer surface of the guiding portion.

7. The lighting device of claim 6, wherein the guiding portion has a guiding wall being cylinder-shaped with arc opening, the guiding wall has a bottom portion contacted with the second end surface of the column member.

8. The lighting device of claim 1, wherein the light seat member has a disk-shaped bottom frame contacted with the heat-removal apparatus, a plurality of connection portions extended inwardly from the disk-shaped bottom frame, and a barrel-shaped portion connected to the connection portions, wherein the air vents are formed between the disk-shaped bottom frame and the barrel-shaped portion.

9. The lighting device of claim 8, wherein a light-source opening is formed in a middle bottom of the barrel-shaped portion, and the light source unit is disposed in the light-source opening, a frame portion is disposed the bottom surface of the barrel-shaped portion and located in a periphery of the light source opening, the frame portion contacts with the first end surface of the column member, wherein a small gap is formed between the bottom surface of the barrel-shaped portion outside of the frame portion and the first end surface of the column member, whereby the air vents communicate with the heat-dissipating passages.

10. The lighting device of claim 8 further comprising a light-focus module, wherein the light-focus module has a reflective lampshade, a transparent cover, a seal ring, and a ring-shaped cover, wherein the reflective lampshade is accommodated in the barrel-shaped portion, the transparent cover covers the reflective lampshade, the seal ring is disposed on the rim of the transparent cover, the ring-shaped cover covers the seal ring, and is fixed on the top end of the barrel-shaped portion.

11. The lighting device of claim 1 further comprising a lampshade, disposed on the periphery of the light seat member to reflect light of the light source module.

12. A light source module corresponding to a heat-removal apparatus having a plurality of heat-dissipating passages penetrating therethrough along a longitudinal direction thereof, the light source module, comprising:
a light source unit disposed on one end of the heat removal apparatus; and
the light seat member covering the light source unit, the light seat member having a plurality of air vents arranged on a bottom portion thereof, the air vents being aligned to the heat-dissipating passages; wherein ambient air flows by the periphery of the light seat member and into the heat-dissipating passages from the air vents of the light seat member.

13. The light source module of claim 12, wherein the light seat member has a disk-shaped bottom frame contacted with the heat-removal apparatus, a plurality of connection portions inwardly extended from an inner edge of the disk-shaped bottom frame inwardly therefrom, and a barrel-shaped portion connected to the connection portions, wherein the air vents are formed between the disk-shaped bottom frame and the barrel-shaped portion.

14. The light source module of claim 13, wherein a light-source opening is formed in a middle-bottom of the barrel-shaped portion, and the light source unit is disposed in the light-source opening, a frame portion is disposed the bottom surface of the barrel-shaped portion, and located in a periphery of the light source opening, the frame portion contacts with one end surface of the column member, wherein a small gap is formed between the bottom surface of the barrel-shaped portion outside of the frame portion and the first end surface of the column member, whereby the air vents communicate with the heat-dissipating passages.

15. The light source module of claim 13 further comprising a light-focus module, wherein the light-focus module has a reflective lampshade, a transparent cover, a seal ring, and a ring-shaped cover, wherein the reflective lampshade is accommodated in the barrel-shaped portion, the transparent cover covers the reflective lampshade, the seal ring is disposed on the rim of the transparent cover, the ring-shaped cover covers the seal ring, and is fixed on the top end of the barrel-shaped portion.

16. The light source module of claim 12, further comprising a lampshade, wherein is disposed on the periphery of the light seat member to reflect light of the light source module.
